(19) United States
(12) Patent Application Publication
(10) Pub. No.: US 2010/0122273 A1
(43) Pub. Date: May 13, 2010

(54) DRIVE UNIT FOR A DATA MEDIUM

(75) Inventor: Norbert Kunze, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,535

(22) PCT Filed: Dec. 18, 2007
(86) PCT No.: PCT/IB2007/055187

§ 371 Date: Jan. 13, 2010

(30) Foreign Application Priority Data
Dec. 22, 2006 (EP) 06127125.0

(51) Int. Cl. G11B 17/028

(52) U.S. Cl. 720/700; G9B/17.006

(57) ABSTRACT

Drive units for a data medium, e.g. a CD or a DVD, generally comprise a turntable and a clamp. It would be advantageous to provide a drive unit having an improved torque 5 transmission from the rotatable parts of the drive unit to the disc. It would also be desirable to allow a better guiding of the disc into a centered position around the axis of rotation from the supporting surface. To better address one or more of these concerns, an embodiment of the invention provides a drive unit for a data medium, comprising a turntable and a clamp for clamping a data medium onto the turntable, wherein the turntable 10 and the clamp can be moved with respect to each other from an unclamped to a clamped position, and, in the clamped position, the turntable and the clamp comprise a form-fit torque transmission between them.

### FIELD OF THE INVENTION

The invention relates to the field of drive units for a data medium and particularly to drive units for compact discs (CD) and digital video discs (also digital versatile discs; DVD) which can be employed in playback or recording modules for data media, wherein the drive unit comprises a turntable and a clamp.

### BACKGROUND OF THE INVENTION

Drive units for a data medium, e.g. a CD or a DVD, usually comprise a turntable and a clamp. In order to provide a rotational motion of the data medium or disc, the turntable is mechanically connected to an electric motor. During a typical cycle of operation, a disc is inserted into the drive unit and lowered onto a supporting surface provided by the turntable. The turntable comprises a centering ring to allow a centric rotation of the data medium around the axis of rotation of the turntable. A disc lowered onto the turntable approximately concentrically with respect to the axis of rotation will be centered by an interaction of the ring and the hole in the middle of the disc.

The clamp of the drive unit clamps or presses the data medium or disc, which is moved into the gap between the turntable and the clamp onto the supporting surface of the turntable. The clamp is not actively driven. In order to hold or clamp the disc onto the supporting surface of the turntable, the turntable and the clamp can be moved from an unclamped to a clamped position. In the unclamped position, the clamp is at a distance from the turntable so that a disc can be lowered onto the supporting surface of the turntable around the centering ring. In the clamped position, the clamp exerts a clamping force on the disc while pressing the disc onto the supporting surface of the turntable. However, there is no mechanical contact between the turntable and the clamp, except for the centering ring touching the clamp. During rotation of the turntable, the torque is only transmitted to the disc by friction between the turntable and the disc which is pressed by the clamp onto the supporting surface.

### OBJECT AND SUMMARY OF THE INVENTION

It would be advantageous to provide a drive unit having an improved torque transmission from the rotatable parts of the drive unit to the disc, while reducing the risk of the disc slipping with respect to the turntable. It would also be desirable to allow a better guiding of the disc into a centered position around the axis of rotation from the supporting surface.

To better address one or more of these concerns, a drive unit for a data medium is provided and comprises a turntable having an axis of rotation, a supporting surface for the data medium and a centering device, and a clamp having an axis of rotation for clamping a data medium onto the supporting surface of the turntable, wherein the turntable and the clamp can be moved with respect to each other from an unclamped to a clamped position, and, in the clamped position, the turntable and the clamp comprise a form-fit torque transmission between the turntable and the clamp.

Once the turntable and the clamp are in a clamped position, a torque transmission is established between them so that the clamp no longer only presses the disc onto the supporting surface of the turntable but the clamp itself, which is in contact with the disc, transmits the torque from the turntable onto the disc. Consequently, the torque transmission between the turntable and the disc is no longer only provided by single-sided friction between the turntable and the disc, but the torque can be transmitted by double-sided friction, i.e. also between the clamp and the disc, respectively. This enhanced torque transmission onto the disc helps to achieve a higher rotational velocity and a higher acceleration of the disc during operation.

In terms of the present application, “form-fit” describes a torque transmission between the turntable and the clamp by mechanical interaction of two corresponding and/or complementary parts of the clamp and the turntable, respectively. During the rotational motion of the disc, the turntable and the clamp will thus provide sections engaging each other in a form-fit manner.

In accordance with an embodiment of the invention, the turntable and the clamp can be moved with respect to each other from an unclamped to a clamped position, while in the unclamped position no torque transmission between the turntable and the clamp is provided. In the unclamped position, the clamp will be rotatable around a second axis of rotation, independently of any rotational movement of the turntable. Once the turntable and the clamp are in the clamped position, the axes of rotation of the turntable and the clamp coincide. If the turntable and clamp are brought into the clamped position, they are brought in engagement with each other so that a form-fit torque transmission is provided.

In accordance with a further embodiment of the invention, the turntable and the clamp can be moved with respect to each other, preferably in an axial direction, i.e. in a direction which is approximately parallel to the axis of rotation of the turntable and the clamp during operation. In the unclamped position, the disc can thus be inserted into the drive unit and lowered onto the supporting surface of the turntable before the device is brought into the clamped position.

In an embodiment of the invention, the torque transmission between the turntable and the clamp is provided by toothed wheel structures provided at the turntable and the clamp. Alternatively or in addition, the torque transmission can be provided by a male and a female eccentric part engaging each other in the clamped position.

In another embodiment of the invention, the turntable must not be provided with a surface made of rubber or any other material having a high coefficient of friction. Due to the double-sided friction between the disc and the supporting surface of the turntable and the clamp, respectively, the torque transmission from the turntable to the disc is sufficient so that the disc does not slip with respect to the turntable, even if the turntable has a metal supporting surface.

In a further embodiment of the invention, the clamp comprises a contact surface which is brought into frictional contact with the data medium or disc in the clamped position. The contact surface has a rotational symmetry around the axis of rotation of the clamp.

In accordance with a further embodiment of the invention, the centering device comprises a centering ring arranged concentrically around the axis of rotation and extending above the supporting surface of the turntable, at least one section of the centering device having an upper edge extending in a radial direction from the centering ring towards the axis of rotation. The radially extending section comprises a bevel sloping from the upper edge in a radial direction towards the centering ring, such that a data medium being lowered onto the turntable is guided into a centered position around the centering ring. The clamp comprises at least one recess in which the radially extending section of the centering device of the turntable extends in a clamped condition of the drive. In this embodiment, the form-fit torque transmission between the turntable and the clamp is provided by the section of the centering device extending in a radial direction from the centering ring towards the axis of rotation. In the clamped condition, the radially extending section of the centering device extends at least partially into a recess formed within the clamp.

However, this embodiment of the invention does not only provide a form-fit torque transmission between the turntable and the clamp, but also addresses the concern of having an improved catching and centering of a disc being inserted into the drive unit.

In an embodiment of the invention, the centering ring of the turntable can only have a height of approximately 500 μm above the supporting surface so as not to enhance the overall thickness of the drive unit. However, in accordance with an embodiment of the invention, the sections of the centering device which extend radially from the centering ring towards the axis of rotation can have a much higher extension from the supporting surface of the turntable, because in the clamped position, they extend into corresponding recesses within the clamp. Thus, no additional height is added to the drive unit in the clamped position.

In an embodiment of the invention, a guiding of a disc being lowered towards the supporting surface of the turntable may be provided by the radially extending sections comprising a bevel sloping from the upper edge of the radially extending sections towards the centering device. The slope of the bevel is directed towards the supporting surface when considered in a direction from the axis of rotation towards the centering ring.

The gain in overall height of the centering device makes it possible to have longer bevels in the radial direction. This in turn leads to a wider range of initial positions of the discs to be lowered onto the turntable which may still be caught by the centering device. The respective embodiment of the invention providing a centering device having a radially extending section which, in the clamped position, at least partially extends into a recess of the clamp would even be advantageous if the turntable and the clamp did not comprise a form-fit torque transmission between them in the clamped position.

In a further embodiment of the invention, the upper edge of the radially extending section of the centering device extends significantly above the supporting surface. A significant extension above the supporting surface means that the radially extending section projects above the upper edge of the centering ring. In a particular embodiment, the radially extending section has a height of more than 1 mm and preferably 1.5 mm above the supporting surface. In this way, the range of positions from which a disc to be lowered onto the supporting surface of the turntable can be caught and brought into a centered position around the centering ring is considerably large.

In a further embodiment, the radially extending section of the centering device comprises, at its upper edge, at least one bevel sloping in a direction perpendicular to the radial direction. This bevel, which extends preferably throughout the radial extension of the radially extending section of the centering device helps to guide the radially extending section of the centering device into the respective recess at the clamp during the transition from the unclamped to the clamped position. When the sloping upper edge of the radially extending section of the centering device meets a part of the clamp, the clamp and the turntable will rotate with respect to each other until the radially extending section of the centering device of the turntable slides into the respective recess of the clamp.

While the bevel can be provided by a single slope in an embodiment of the invention, it may be advantageous if the upper edge of the radially extending section is arranged in a roof-top manner in order to provide slopes in two directions which are generally perpendicular to the radial direction.

In a further embodiment of the drive unit according to the invention, the radially extending section of the centering device is a spoke-like structure covering only a segment of a circle formed by the centering ring, wherein the clamp comprises a spoke-like structure extending radially, and, in a clamped condition, the respective spokes of the turntable and the clamp engage each other, providing a form-fit torque transmission between the turntable and the clamp.

If in an embodiment of the invention, the spoke-like structures provided at the turntable and the clamp comprise at least one bevel sloping in a direction perpendicular to the radial direction, blocking of the mechanical transition from the unclamped to the clamped position can be avoided, because under ideal conditions there is only a line contact between the spokes of the respective parts, such that a guiding of the spokes of one part into the recesses of the other is ensured.

It is desirable that the turntable and the clamp comprise a plurality of spoke-like structures.

In another embodiment of the invention, one of the turntable and the clamp comprises three spoke-like structures and the other comprises four spoke-like structures. This allows a perfect matching of the spokes of one part into the recesses of the other part with a smaller loss of rotational motion. Furthermore, only a single pair of roof-shaped spokes at the clamp or the turntable, respectively, can get into contact at the same time during transition from the unclamped to the clamped position.

The different embodiments of the present invention are advantageously employed in a playback or recording module for a data medium. In accordance with an embodiment of the invention, a drive unit as well as a playback or recording module may be a CD or a DVD disc player.

In accordance with a further embodiment of the invention, a playback module may be employed in an audio or video system, advantageously in a portable or car system.

These and other aspects of the invention are apparent from and will be elucidated with reference to the embodiments described hereinafter.

### BRIEF DESCRIPTION OF THE DRAWINGS

FIG. 1 is a perspective top view of a turntable in accordance with an embodiment of the present invention.

FIG. 2 is a perspective bottom view of a clamp in accordance with an embodiment of the invention.

FIG. 3 is a cross-sectional view through a turntable and a clamp in the clamped position in accordance with an embodiment of the invention.

FIG. 4 is a top view of the turntable and the clamp in a clamped position in accordance with an embodiment of the invention.

### DESCRIPTION OF EMBODIMENTS

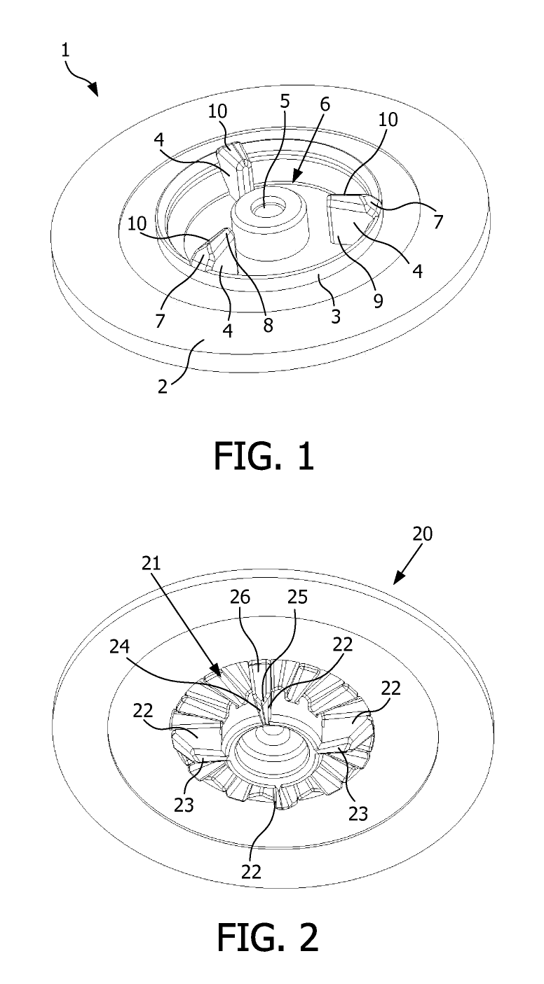

FIG. 1 shows a turntable 1 in accordance with an embodiment of the present invention, comprising a supporting surface 2, a centering ring 3 and three radially extending sections 4 of the centering device. While the supporting surface 2 of the turntable 1 serves as a carrier for a CD or DVD disc being inserted into the drive unit, the centering ring 3 of the centering device of the turntable serves to position the disc in a centered direction around the center 5 of the turntable 1. Therefore, the outer diameter of the centering ring 3 essentially corresponds to the inner diameter of the hole in a DVD or CD disc. The centering ring 3 has a height of 500 μm above the planar surface of the supporting surface 2. An annular recess 6 surrounding the centering ring 3 is provided in the supporting surface 2 which, in an embodiment of the invention, may be filled with rubber or any other sticky material providing a high coefficient of friction.

The radially extending sections 4, which are part of the centering device of the turntable, serve two general purposes. When the turntable 1 and the clamp 20 as shown in FIG. 2 are in the clamped position, the radially extending sections or spokes 4 of the turntable 1 extend into the corresponding recesses 21 of the clamp 20. In the clamped position, the spokes 4 of the turntable 1 will then be in engagement with corresponding spokes 22 of the clamp 20, providing a form-fit torque transmission between the turntable 1 and the clamp 20.

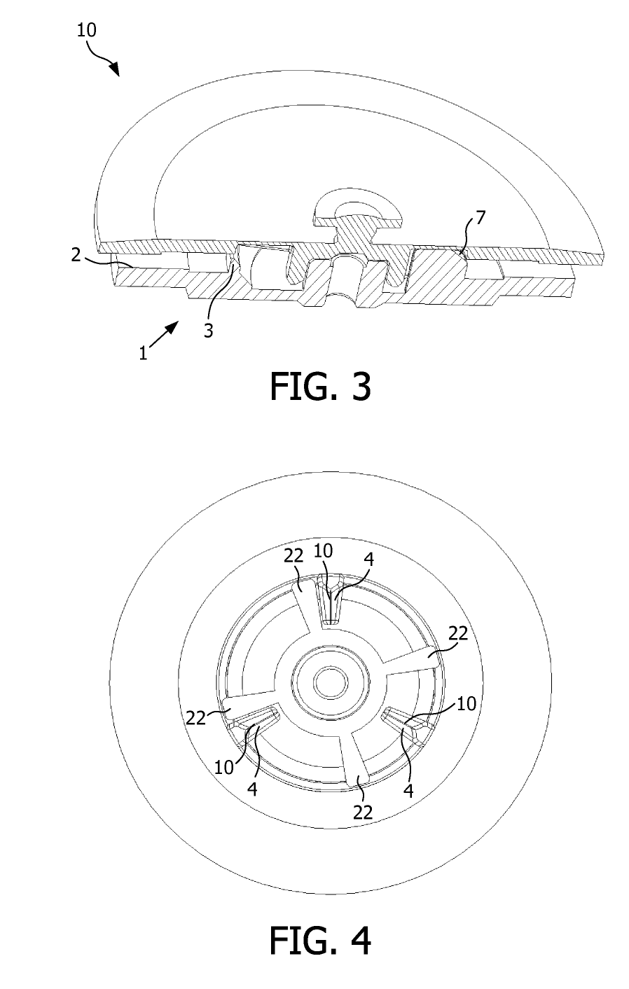

The spoke-like radially extending sections 4 of the centering device of the turntable 1 provide a guiding of a disc to be inserted into a drive unit and lowered onto the supporting surface 2 of the turntable 1 over an extended range of off-center positions. Therefore, each of the three spoke-like structures 4 comprises a bevel 7 inclined in a radial direction so that it extends from an upper edge 10 of the spoke 4 towards the outer diameter of the centering ring 3. Any CD or DVD inserted into the drive unit in an off-center position with respect to the center 5 of the turntable 1 will thus be guided by the bevel 7 of the spokes 4 into the centered position, in which the outer diameter of the centering ring 3 matches the inner diameter of the hole in the middle of the disc. The bevel 7 of the spoke 4 leading to an alignment of a disc lowered onto the turntable 1 can be seen in the cross-sectional view in FIG. 3. In order to enhance the centering functionality provided by the drive unit comprising the turntable 1 and the clamp 20, each spoke-like structure 22 associated with the clamp 20 also provides radially extending bevels 26, which will help to center the disc while bringing the clamp 20 into the clamped position of the drive unit.

As depicted in FIG. 4, the turntable 1 has three spokes 4, whereas the clamp 20 has four spokes 22. In this configuration, there is a perfect match of the spokes 4, 22 with the respective recesses of the other part, leading to a torque transmission between the turntable and the clamp in both directions of rotation. While the side surface of a first spoke 4 of the turntable 1 abuts a side surface of a first spoke 22 of the clamp 20, a second side surface of a second spoke 4 abuts a second side surface of a second spoke 22 of the clamp 20.

While the spokes 4 of the turntable 1 are mutually spaced 220° apart, the spokes 22 of the clamp 20 are mutually spaced 90° apart. Due to this geometry, only a single spoke 4 of the turntable 1 and a single spoke 22 of the clamp 20 can, at each instance, be positioned above each other during transition of the drive unit from an unclamped to a clamped position.

The spokes 4 of the turntable 1 as well as the spokes 22 of the clamp 20 are provided with a rooftop-like upper edge 10, 23, comprising two bevels 8, 9 and 24, 25, respectively. During transition of the drive unit from an unclamped to a clamped position, the turntable 1 and the clamp 20 will thus always move with respect to each other so that the spokes 4, 22 can engage each other. If two spokes meet during a mutually axial movement of the turntable 1 and the clamp 20, the bevels 8, 9 and 24, 25 of the roof tops will provide a rotational movement of the turntable 1 and the clamp 20, such that the two spokes 4, 22 move until the side faces abut each other.

In the embodiment shown in FIGS. 1 to 4, the turntable 1 as well as the clamping structure 20 is made of molded plastic. As the disc inserted into the drive unit is clamped in frictional contact with the turntable 1 as well as the clamp 20, the torque provided by the electric engine to which the turntable is connected is directly transmitted onto the disc.

In the embodiment shown in FIGS. 1 to 4, the upper edges 10 of the spokes 4 of the turntable 1 extend 1.5 mm above the supporting surface 2 of the turntable 1.

The invention has been shown and described in detail in the drawings and the foregoing description. However, it should be noted that this description has been given by way of non-limiting example and that the invention is not limited to the embodiments described hereinbefore.

Other variations of the described embodiments can be understood and effected by those skilled in the art in practicing the claimed invention, from a study of the drawings, the disclosure and the appended claims. In the claims, use of the verb “comprise” and its conjugations does not exclude other elements or steps, and the indefinite article “a” or “an” does not exclude a plurality. The fact that certain measures are recited in mutually different dependent claims does not indicate that a combination of these measures cannot be used to advantage. Any reference signs in the claims should not be construed as limiting the scope.

### LIST OF REFERENCE NUMERALS

1 turntable
2 supporting surface
3 centering ring
4, 22 radially extending section, spoke
5 center of turntable
6, 21 recess
7, 26 radially extending bevel
8, 9, 24, 25 bevel
10, 23 upper edge
20 clamp

1. A drive unit for a data medium comprising
a turntable (1) having an axis of rotation, a supporting surface (2) for the data medium and a centering device, and
a clamp (20) having an axis of rotation for clamping a data medium onto the supporting surface (2) of the turntable (1),
wherein said turntable (1) and said clamp (20) can be moved with respect to each other from an unclamped to a clamped position, and
in the clamped position, said turntable (1) and said clamp (20) comprise a form-fit torque transmission between said turntable and said clamp.

2. A drive unit according to claim 1, wherein said centering device comprises
a centering ring (3) arranged concentrically around said axis of rotation and extending above said supporting surface (2) of the turntable (1),
at least one section (4) of the centering device having an upper edge (10) extending in a radial direction from said centering ring (3) towards said axis of rotation,
wherein said radially extending section (4) comprises a bevel (7) sloping from said upper edge (10) in a radial direction towards said centering ring (3), such that a data medium being lowered onto the turntable (1) is guided into a centered position around said centering ring (3), and
said clamp (20) comprises at least one recess (21) in which said radially extending section (4) of the centering device of the turntable extends (1) in a clamped condition of the drive.

3. A drive unit according to claim 2, wherein said upper edge of the radially extending section (4) of the centering device extends significantly above the supporting surface.

4. A drive unit according to claim 2, wherein said radially extending section (4) of the centering device comprises, at its upper edge, at least one bevel (8, 9) sloping in a direction perpendicular to the radial direction.

5. A drive unit according to claim 2, wherein said radially extending section (4) of the centering device is a spoke-like structure covering only a segment of a circle formed by the centering ring (3),
wherein said clamp (20) comprises a spoke-like structure (22) extending radially, and, in a clamped condition, the respective spoke-like structures (4, 22) of the turntable (1) and
the clamp (20) engage each other, providing a form-fit torque transmission between said turntable and said clamp.

6. A drive unit according to claim 5, wherein said turntable (1) and said clamp (20) comprise a plurality of spoke-like structures (4, 22).

7. A drive unit according to claim 5, wherein one of said turntable (1) and said clamp (20)
comprises three spoke-like structures and the other comprises four spoke-like structures.

8. A drive unit according to claim 1, wherein said torque transmission between the turntable (1) and the clamp (20) is provided by toothed wheel structures provided at the turntable and the clamp.

9. A playback or recording module for a data medium comprising a drive unit according to claim 1.

10. An audio or video system comprising a playback or recording module according to claim.
